(19) United States
(12) Patent Application Publication
(10) Pub. No.: US 2010/0308537 A1
(43) Pub. Date: Dec. 9, 2010

(54) Method and apparatud for nutrition education

(76) Inventors: Sidonie Decourt, Hermance (CH); Lee Weinstein, Arlington, MA (US)

Correspondence Address: LEE WEINSTEIN, 32A FAIRMONT STREET, ARLINGTON, MA, 02474, US

(21) Appl. No.: 12/080,055

(22) Filed: Mar. 31, 2008

(51) Int. Cl. A63F 3/00; G09B 19/22

(52) U.S. Cl. 273/243; 434/128

(57) ABSTRACT

A nutrition board game is disclosed with novel aspects that promote players learning various aspects of proper nutrition by playing the game. Both chance and knowledge contribute toward each player advancing in the game. In one aspect, nutrition-related questions must be answered to advance in the game. In another aspect different activities (such as eating a specific food, drinking water, or doing jumping jacks) are interspersed to accelerate learning.

### FIELD OF THE INVENTION

The field of the invention relates to nutrition, education, and board games.

### BACKGROUND OF THE INVENTION

Board games have existed as family entertainment for many years. Virtually all board games are designed to be entertaining. In some board games, advancing in the game is purely a matter of luck (often determined by rolling dice). In some board games (for example, trivial pursuit) knowledge and/or skill of a player may be part of what determines advancement. Some board games which serve as an educational aid have existed for a long time. The most well known example may be the game of Monopoly, which provides some education about the nature of money, while providing entertainment as well. A more highly educational example of a monetary board game is Robert Kiyosaki's “Cash Flow” game, in which participants learn to build passive income through saving, investing wisely, and starting businesses.

There is a need in society for games which are entertaining to children and adults, and which provide education on useful topics.

As more and more is understood about health and longevity, there is more information for consumers to sift through to try to become well informed in these topics. Unfortunately, many of the sources providing “information” on such topics are inherently biased because they are marketing some food or nutritional supplement or the like. There is a need for unbiased sources of nutrition education which provide engaging and entertaining ways for consumers to learn about these important topics. Since parents often find that their children's food and beverage desires are strongly influenced by entertaining advertisements, there is a need for entertaining and engaging opportunities for children to learn about nutrition.

### SUMMARY OF THE INVENTION

It is an object of the present invention to provide an entertaining, engaging, and enjoyable medium for children and adults to learn about nutrition. In one aspect it is an object of the present invention to provide knowledge about what foods are part of different food groups. In another aspect, it is an object of the present invention to provide knowledge about beneficial levels of consumption of different food groups. In another aspect, it is an object of the present invention to provide accelerated learning, by involving a number of senses (for example visual, auditory, kinesthetic, and gustatory).

In a preferred embodiment, the present invention provides a board game which is both engaging and informative for both children and adults alike. In one aspect, advancement in the game is determined in part by chance (rolling a die). In another aspect, advancement in the game is determined by knowledge (answering nutrition-oriented questions correctly). In a third aspect, the present invention provides physical entertainment and involvement by requiring players under some circumstances to do a physical activity (such as jumping jacks, or drinking a glass of water).

In a preferred embodiment of the present invention, each player has a game piece which marks player position on a shared game board. In this document, the shared game board may also be referred to as the “main board”. In a preferred embodiment, each player also has an individual game board. The object of each player is to collect tokens to fill up his or her individual game board.

Each player rolls a die at his or her turn to determine advancement on the main board. Thus, for entertainment value and to randomize certain elements of the game, part of the game depends on chance (the rolling of the die). The die roll will land the player's game piece on a particular square on the main board. In a preferred embodiment, the type of square landed on determines the type (for instance color) of token the player gets for answering a question correctly. In a preferred embodiment, questions are read from a randomly shuffled deck of cards (giving a second element of chance to the game). In a preferred embodiment, answering a question correctly entitles a player to place two game tokens of the type indicated by the square on which that players game piece currently sits on the main board.

In a preferred embodiment, in order to increase the entertainment value of the game, some squares on the main board indicate that a player is not to be asked a question, but rather given an entertaining task to complete (such as doing some jumping jacks, or drinking a glass of water, or eating some of a certain food). In some embodiments, entertaining tasks may not result in any advancement toward completion of the game.

In a preferred embodiment, the individual player boards (also herein referred to as token boards) have six rows of spaces to be filled in with tokens, and the six rows correspond to six food groups that should be consumed on a daily basis defined as Carbohydrates, Nuts & Seeds, Protein, Fruits, Vegetables, and Water. In a preferred embodiment, the number of tokens of each type collected to win the game is proportional to the number of servings of that food group that a person should consume on average in a day. A preferred embodiment provides for players a printed list of example foods from each of the food groups, and example adult and child portion sizes for each food. A player completes the game by placing tokens on all token spaces on the player's token board. In a preferred embodiment, the game ends when the first player to fill his or her token board fills his or her token board.

In a preferred embodiment the number of squares on the main board which direct a player to collect a given type of token (if a question is correctly answered) is proportional to the number of spaces of that token type which exist on the individual players' token boards. Although this makes equal the statistical likelihood that a player will fill any given row on his or her token board, the various of this probability is not zero, so by random chance a given player may fill in one row of tokens on his or her token board with ease, and not wind up landing on a main-board square that will provide a chance to get a token in another needed row. To avoid overly frustrating a player who encounters such a chance fate, in a preferred embodiment, each player is provided with at the start of the game with a limited supply of wind-card game pieces, which may be used in certain situations to obtain tokens of one type for correctly answering a question which would normally have provided a token of a different type. In a preferred embodiment, players of a younger age may be given more of such wild-card game pieces, in order to provide a handicapping effect

### BRIEF DESCRIPTION OF THE DRAWINGS

FIG. 1 is a pictorial rendition of the main board of a preferred embodiment of the present invention.

FIG. 2 is a pictorial rendition of an individual player board of a preferred embodiment of the present invention.

FIG. 3 is a pictorial rendition of game pieces used by individual players in a preferred embodiment of the present invention.

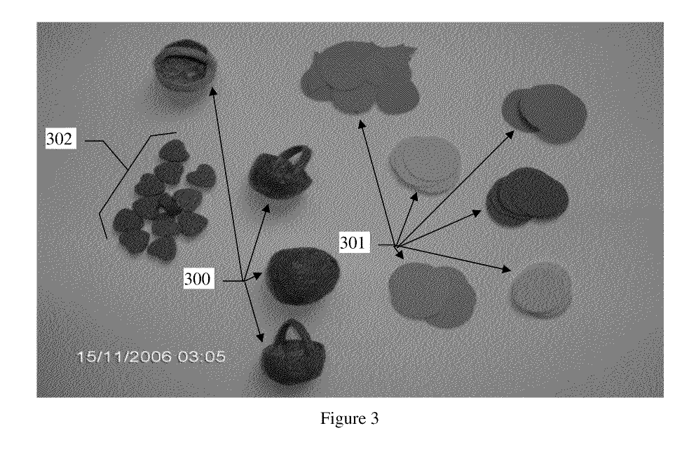

### DETAILED DESCRIPTIONS OF SOME PREFERRED EMBODIMENTS

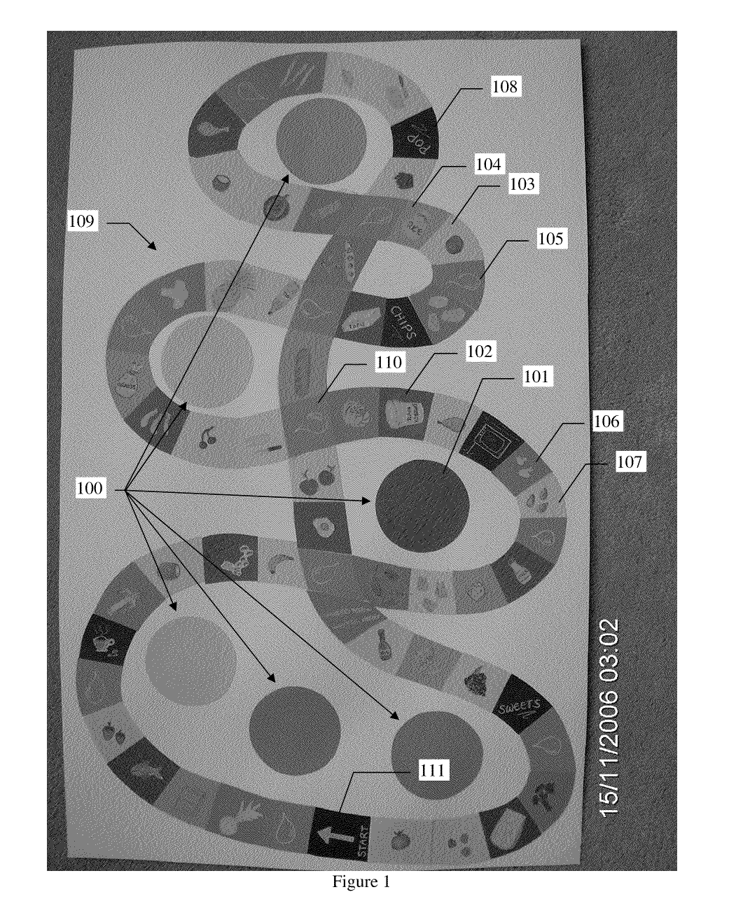

FIG. 1 is a pictorial rendition of the main board of a preferred embodiment of the present invention. The main board comprises six circular chip storage pads 100, and a looped serpentine playing track 109, which is made up of a sequence of possible game positions such game positions 102, 103, 104, etc. Some game positions (such as game position 110) are traversed multiple times in one trip around serpentine track 109, due to the self-intersecting nature of serpentine track 109.

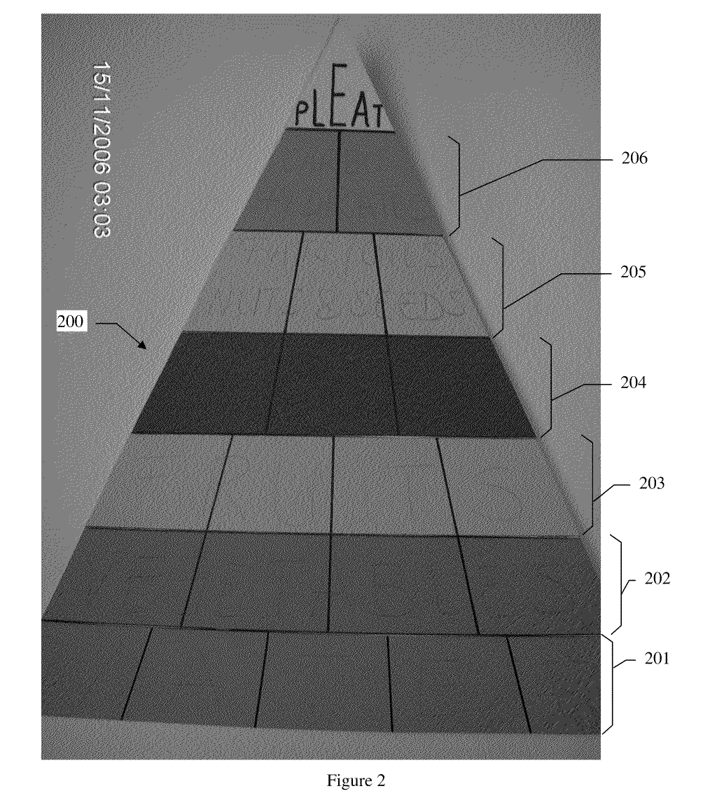

FIG. 2 is a pictorial rendition of an individual player board (token board) of a preferred embodiment of the present invention. In a preferred embodiment, each pyramidal token board 200 is divided into layers 201-206, and each layer is divided into multiple segments. During play, it is the object of each player to obtain a game token 301 for each segment of each layer 200-206 in the player's food pyramid 200. Each layer in pyramid 200 represents a different food group. In a preferred embodiment, layer 201 represents water, and is divided into five segments. Layer 202 represents vegetables, and is divided into four segments. Layer 203 represents fruits, and is divided into four segments. Layer 204 represents protein, and is divided into 3 segments. Layer 204 represents fats, oils, nuts, & seeds, and is divided into 3 segments. Layer 205 represents carbohydrates, and is divided into two segments.

In a preferred embodiment, each player has a game piece 300, which he or she advances along serpentine track 109 of the main board. Each player starts with his or her game piece 300 on start square 111. Advancement of game pieces is determined by rolling a die. In a preferred embodiment, position squares along serpentine track 109 are divided into categories which match the categories which define the rows of token spaces on token board 200, and the number of each category of such squares on serpentine track 109 is proportional to the number of token spaces in the corresponding row on the token boards. For instance, in a preferred embodiment, there are three times as many “nuts & oils” squares (such as “nuts & oils” square 107) on the main board as there are on the “nuts & oils” token spaces 205 on a token board. Likewise there are three times as many “vegetables” squares (such as “vegetable” square 106) on the main board as there are on the “vegetables” token spaces 202 on a token board. Likewise there are three times as many “water” squares on the main board (such as “water” square 105) as there are on the “water” token spaces 201 on a token board. Likewise there are three times as many “carbohydrate” squares on the main board (such as “carbohydrate” square 104) as there are on the “carbohydrate” token spaces 206 on a token board. Likewise there are three times as many “protein” squares on the main board (such as “protein” square ______) as there are on the “protein” token spaces 204 on a token board. Likewise there are three times as many “fruits” squares on the main board (such as “fruits” square ______) as there are on the “fruits” token spaces 203 on a token board.

In a preferred embodiment, each player's turn starts with the rolling of a die, which determines the advancement of that players game piece 300. Once game piece 300 is advanced, the square (on serpentine track 109) on which that player's game piece lands indicates the type of tokens that player will collect if that player answers a question correctly. In a preferred embodiment, questions are provided by the player selecting a card from the top of a stack of previously randomly shuffled question cards. In a preferred embodiment, if a player answers the question correctly, he or she may place up to two tokens (of the type indicated by the main board square on which his or her game piece sits) on empty spots of that token type on his or her token board.

In a preferred embodiment, at the start of the game, each player receives a number of wild-card game pieces 302. In a preferred embodiment, if a player correctly answers a question on his or her turn during the game, and the token row for the type of token associated with his or her game piece position on serpentine track 109 is full, he or she may elect to trade a wile-card game piece for two tokens of a different type, which may be placed on a non-full row on his or her token board.

In a preferred embodiment, serpentine track 109 includes some squares which do not correspond to a food group, but rather direct a player to engage in an activity designed to be stimulating and engaging to that player and/or the other players.

In a preferred embodiment, such activities might include doing jumping jacks and the like.

In a preferred embodiment, answering questions correctly may also result in a player receiving a reward, such as a preferred food to eat. In an preferred embodiment, some questions will direct a player to engage in an activity as part of answering the question, for instance “taste the mystery food and correctly identify its food group or food groups”.

In a preferred embodiment for playing in a car, game pieces and tokens are preferably magnetized, and the main board and token boards of the present invention contain a ferromagnetic material (such as steel), such that game pieces and tokens stick in place when placed.

In a preferred embodiment of the present invention to be played on one or more personal computers, the random-number-generating function of rolling a physical die is replaced by an software random-number generator, the drawing of cards with questions on them is replaced by software generation of such questions. In a preferred embodiment of the present invention to be played on multiple computers across a network such at the Internet, players' computers are equipped with microphones and web-cams, and images of one or more other players are shown on the screen of each player. In a preferred embodiment using web cams, the image of the player who's turn it is visible to all other players.

In a preferred embodiment of the present invention used to facilitate learning of subjects other than nutrition, the interspersing of physical tasks and question answering serves to keep participants entertained and engaged just as it does in an embodiment for use in learning about nutrition.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. Means for educating people about nutrition, said means comprising:
A main game board for use by one or more players;
One individual token board for each player;
A deck of cards, a majority of said cards having nutrition-related questions printed thereon;
A game piece for each player;
A token board for each player, each token board comprising a plurality of token spaces;
A plurality of tokens for placing on said token boards.

2. A nutrition-oriented board game comprising a game board, player-representative game pieces, correct-answer-representative game tokens, and a set of nutrition oriented questions, said game board comprising a pathway of possible game piece positions, said possible game piece positions comprising subsets of positions representative of different food groups.

3. The nutrition-oriented board game of claim 2, wherein said game piece positions further comprise a subset of positions indicative that a player landing on theat position should engage in a physical activity.

4. The board game of claim 2, wherein said pathway is self-intersecting, and un-ending by nature of being closed.

5. A method of learning about a subject, comprising generating a random number, moving a game piece said random number of positions to a landing position along a multi-position closed pathway on a game board, and, depending said landing position, either answering a question from a set of questions, or engaging in a physical activity.

6. The method of claim 5, further comprising placing a token on at least one prescribed space on said token board each time a question is answered correctly and such prescribed space for such token is available on said token board.

7. The method of claim 5, wherein said game board is a physical game board and said random number is generated by casting a die.

8. The method of claim 5, wherein said game board is a virtual game board represented on the display of at least one computer, and said random number is generated in using a software random number generator.
